(19) United States
(12) Patent Application Publication
(10) Pub. No.: US 2013/0281894 A1
(43) Pub. Date: Oct. 24, 2013

(54) THERMAL TYPE MASSAGE DEVICE

(71) Applicant: Huang Ling Ling, Taipei City (TW)

(72) Inventor: Huang Ling Ling, Taipei City (TW)

(73) Assignee: A-HOT INTERNATIONAL CO., LTD.

(21) Appl. No.: 13/454,313

(22) Filed: Apr. 24, 2012

(51) Int. Cl. A61H 1/00

(52) U.S. Cl. 601/19

(57) ABSTRACT

A thermal type massage device uses an ignited catalyst as a heat source for producing temperature, collocated with a cotton (sponge) material absorbed with volatile liquid, so that the heat source may continuously produce heat, enabling the surface temperature of the thermal type massage device to rise. Therefore, thermal efficacy can be achieved in use. Moreover, one end of the thermal type massage device can rotate, a surface of which is formed with protruding particles or ribs, and a user can feel warm via the rotation on the skin surface and surface temperature of the end, and massage at the same time by using the protruding particles or ribs.

### FIELD OF THE INVENTION

A thermal type massage device is provided for a user to massage a body, in particular, the present invention relates to a thermal type massage device having a massage effect by using an ignited catalyst as a heat source, collocated with a cotton material (or sponge) material absorbed with volatile liquid, to continuously produce heat energy.

### RELATED ART

Due to problems of working pressures, bodies of most modern people are overtired, then problems such as pains in a shoulder, a neck or other parts of the body, is further caused. Preferable solutions are still mainly to properly adjust a working method and a daily routine, improve diets, and normally exercise, which are obviously optimal choices. However, some people have to turn to ways such as medicines and therapies, and also some people use proper physical methods to achieve objectives such as soothing pressure release and pain alleviation, for example, yoga. Massage is another way to relax the body and achieve an effect of properly alleviating the pain. Therefore, lots of appliances used for the massage emerge in the market, including a common handheld vibrating massager, which generally uses electricity as the power source, so that the user can massage the body such as the shoulder, the neck or the head. Moreover, some massage appliances further have a thermal effect, so that the user may enjoy a hot compress effect while massaging. A principle thereof is as follows: a temperature rise effect is made by using, for example, a micro heating chip, a far-infrared device and the same, and such massage appliances need to be collocated with electricity in use. The massage device of this type has desirable massage and thermal effects, but has a large size and is quite inconvenient to carry. Furthermore, since electricity is required as the power source, the massage device of this type is inappropriate for being used outdoors or in an environment without electricity. Therefore, the environment where the massage device of this type is applicable is quite restricted. Referring to Thermal Moxibustion Rolling Rod (1) (ROC Patent No. I309979), disclosed is a massage rolling rod producing a thermal effect without electricity. It can be known from the content described in the patent specification that, a moxibustion strip is mainly used as the heat source, and one end thereof can rotate, so that the user can massage the skin surface with the rotatable part; in addition, a thermal effect can be achieved via the produced temperature while massaging. However, after carefully understanding a composition structure thereof, it can be found that, the moxibustion strip and a member receiving the moxibustion strip are quite complicated, so how to simplify the composition structure to improve convenience and safety in use is a problem which requires an immediate solution.

### SUMMARY OF THE INVENTION

In view of the abovementioned problems, the inventors do relevant researches and make analysis on the structural composition and the using manners of the massage device as well as the user habits according to years of experience in designing and manufacturing relevant products, and expect to develop a more proper massage device. Therefore, a main objective of the present invention is to provide a thermal type massage device with a simple structure, high safety, and both massage and thermal effects.

In order to achieve the abovementioned objective, the present invention mainly uses a catalyst as a heat source, collocated with a cotton (or sponge) material absorbed with volatile liquid, for implementation, so that the massage device can continuously have a thermal effect within an effective time period due to heat energy. Moreover, one end of the thermal type massage device described in the present invention is disposed with a massage head that can rotate. A user may enable a surface of the massage head to gently touch a portion of the human body to be massaged and massage the human body with the surface of the massage head through back-and-forth moving, and a thermal effect is provided simultaneously.

As abovementioned, the present invention mainly uses an ignited catalyst as a heat source, collocated with a cotton material absorbed with volatile liquid, so that the heat energy can be provided continuously; in addition, both massage and thermal effects can be simultaneously achieved by using a simple rotation structure. The structural composition thereof is simple, an overall size of a physical finished product is small, electricity is not required, and it is very convenient for the user to carry and use.

For ease of clear understanding of the structural composition, embodiments and effects made after implementation of the present invention for the examiner, the present invention is described in detail below with reference to the drawings.

### BRIEF DESCRIPTION OF THE DRAWINGS

FIG. 1 is a schematic composition view of the members of the present invention;

FIG. 2 is a three-dimensional outside view of the present invention;

FIG. 3 is a schematic implementation view (1) of the present invention;

FIG. 4 is a schematic implementation view (2) of the present invention;

FIG. 5 is a schematic implementation view (3) of the present invention;

FIG. 6 is another preferred embodiment (1) of the present invention;

FIG. 7 is a schematic operation view of the preferred embodiment (1);

FIG. 8 is another preferred embodiment (2) of the present invention; and

FIG. 9 is another preferred embodiment (3) of the present invention.

### DETAILED DESCRIPTION OF THE INVENTION

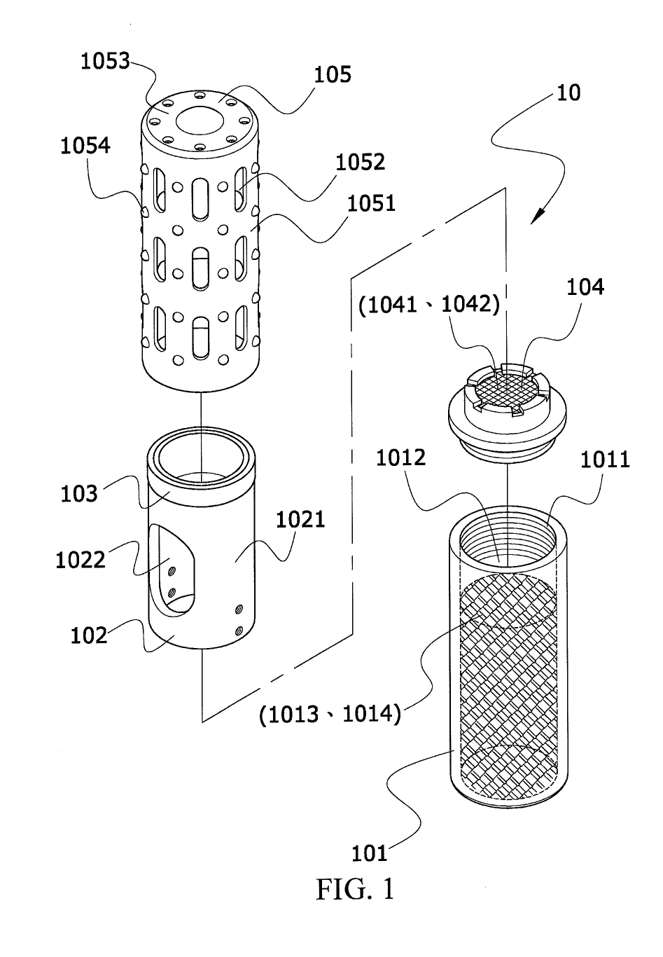

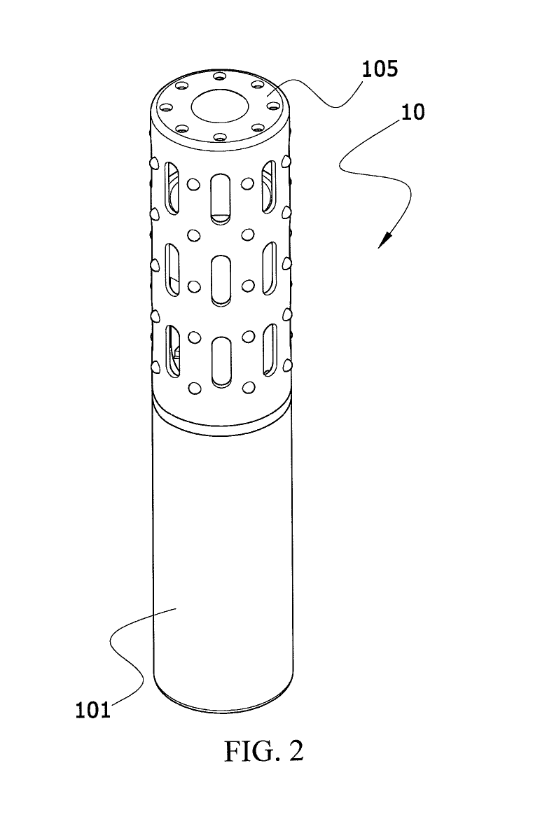

Referring to FIG. 1, a schematic composition view of members of the present invention is shown. The called thermal type massage device 10 of the present invention mainly includes a holding base 101, a connection tube 102, a pivot 103, a catalyst body 104 and a massage head 105. As shown in FIG. 1, the holding base 101 has an open end 1011, inside which an accommodation space 1012 is formed, and a cotton material 1013 is filled in the accommodation space 1012 and absorbs volatile liquid 1014, such as alcohol or oil (cleaning naphtha) with high volatility. One end of the connection tube 102 may be fixedly disposed at the open end 1011 of the holding base 101, and the connection tube 102 is hollow, so that the volatile liquid absorbed by the cotton material 1013 may pass through the connection tube 102 during volatilization. In addition, at least one ignition opening 1022 is formed on a tube wall 1021 of the connection tube 102. Moreover, the pivot 103 is disposed at the other end of the connection tube 102. Referring to FIG. 1 again, the catalyst body 104 is disposed in the connection tube 102, or may be disposed between the connection tube 102 and the open end 1011, and mainly consists of flame retardant cotton 1041 and platinum 1042, in which the platinum 1042 may be adhered to or covered on the surface of the flame retardant cotton 1041, and has a catalytic effect. The massage head 105 is disposed on the connection tube 102, and after the assembly, the massage head 105 may rotate relatively to the holding base 101 via rotation of the pivot 103. Moreover, one or multiple air vents 1052 are formed on a surface 1051 of the massage head 105, and one or multiple protruding particles 1054 (or protruding ribs) may be further formed on the surface 1051 or a top end 1053. As described in the above, after the assembly, an appearance of the present invention is shown in FIG. 2, which is a three-dimensional outside view of the present invention.

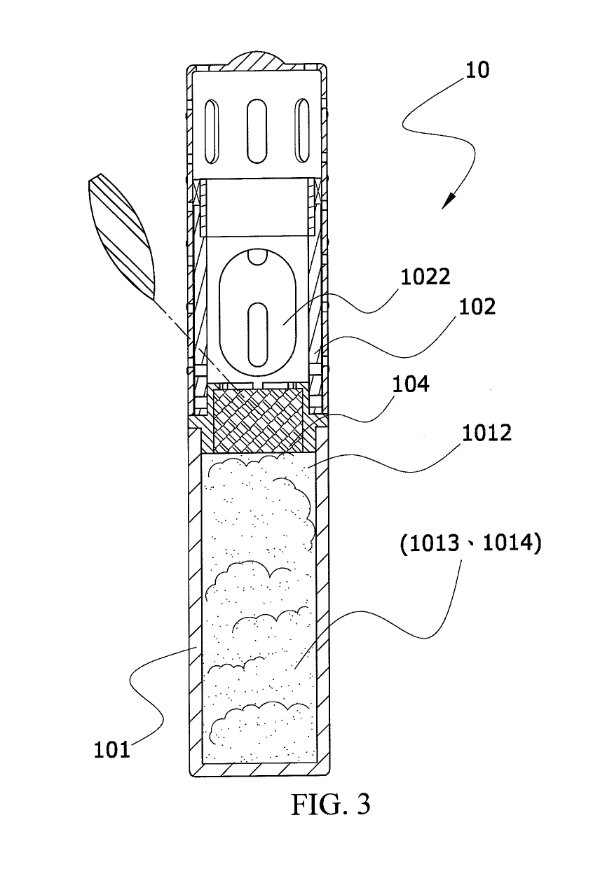

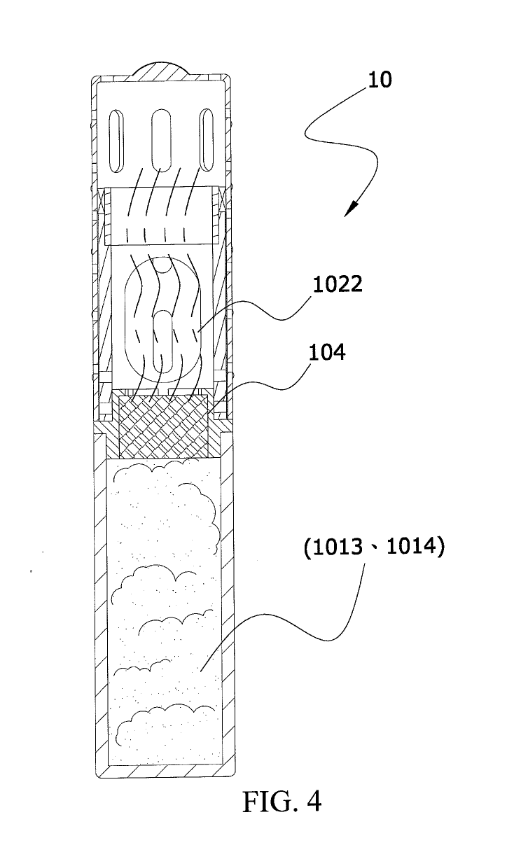

Referring to FIG. 3, a schematic implementation view (1) of the present invention is shown. As shown in FIG. 3, in use, it is required to first fill the volatile liquid into the accommodation space 1012 of the holding base 101, so that the cotton material 1013 fully absorbs the volatile liquid 1014. Then, an ignition device, such as a lighter or a jet lighter, is used to ignite the catalyst body 104 at the ignition opening 1022 (about 4-5 seconds), and after the ignition, the massage head 105 is disposed on the connection tube 102. Referring to FIG. 4, a schematic implementation diagram (2) of the present invention is shown. In a normal case, a surface layer of the ignited catalyst body 104 shows a flameless burning state. During implementation, gas 1014′ of the volatile liquid 1014 inside the accommodation space 1012 is absorbed by the flame retardant cotton 1041 of the catalyst body 104, and when the catalyst body 104 burns to a certain temperature, the platinum at the surface layer produces a catalysis effect, and then a slow burning situation appears. Although there is no flame, the catalyst body still burns. Therefore, heat energy is continuously produced through oxidation on the surface layer. In addition, the flame retardant cotton 1041 does not burn, which significantly improves use safety, and in this way, the surface temperature of the whole thermal type massage device 10 also rises. Moreover, due to heat conduction and heat radiation, the surface of the massage head 105 is warmed.

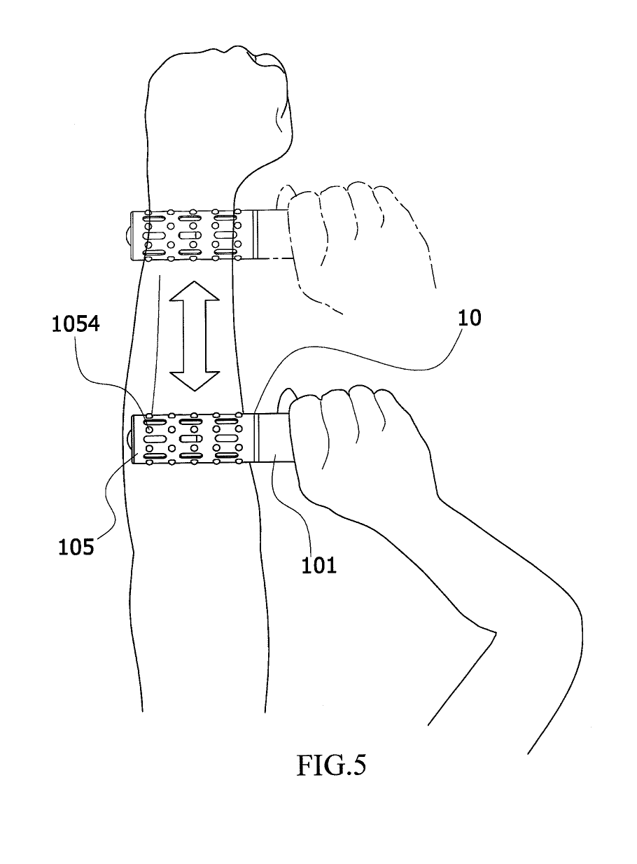

Then, referring to FIG. 5, a schematic implementation diagram (3) of the present invention is shown. As shown in FIG. 5, when the surface of the massage head 105 is warmed properly, the user can hold the holding base 101 of the thermal type massage device 10 by a single hand, enable the surface of the massage head 105 to gently touch a portion of the human body to be massaged, and move the massage head back and forth on the skin surface. Since the massage head 105 may rotate relatively to the holding base 101, the massage head 105 may rotate with respect to a pressed position. In addition, the pressed position may have a massage effect via the relative force between the particles 1054 (or the protruding ribs) on the surface of the massage head 105 and the pressed position. Moreover, since the surface of the massage head 105 is properly warmed, the pressed position may have a thermal effect during the massage. In this way, in the implementation of the present invention, the pressed position may have both massage and thermal effects.

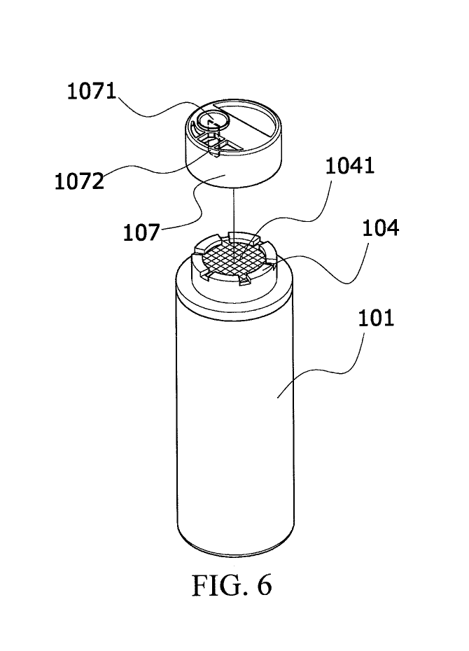

Referring to FIG. 6, another preferred embodiment (1) of the present invention is shown. As shown in FIG. 6, in order to meet the demands of more users, such as the elders, women and persons who have difficulties in operating a lighter, the present invention is further designed with a function of electronic ignition. In the present invention, an electronic ignition module 107 is disposed above the original catalyst body 104, and has an electrical contact point 1071 and more than one heat-conducting butt 1072 connected to the electrical contact point 1071, in which, preferably, the heat-conducting butt 1072 is made of a metal material. In addition, when the electronic ignition module 107 is disposed above the catalyst body 104, a terminal of the heat-conducting butt 1072 is in contact with the flame retardant cotton 1041 of the catalyst body 104.

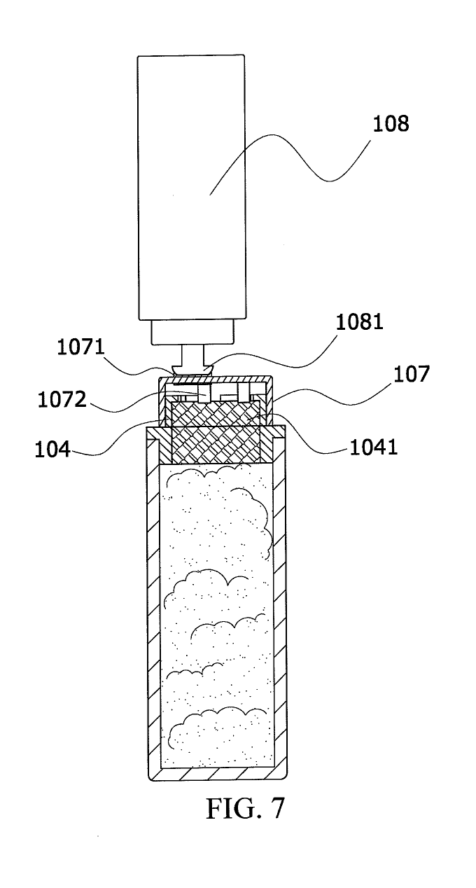

Then, referring to FIG. 7, a schematic operation view of the preferred embodiment (1) is shown. As shown in FIG. 7, when the user intends to use the present invention, the user first uses a power supply device 108 (a battery and a battery holder), and enables a conductive end 1081 of the power supply device to contact the electrical contact point 1071 of the electronic ignition module 107. Since the whole ignition module 107 may produce a resistance effect, when the power supply device 108 continuously powers the electrical contact point 1071, the heat-conducting butt 1072 may produce a high temperature due to the resistance effect, and further ignites the flame retardant cotton 1041, so that the flame retardant cotton starts to work. In this way, the user does not need to use a lighter or a jet lighter for ignition, thereby improving the convenience for use and further improving the safety in use.

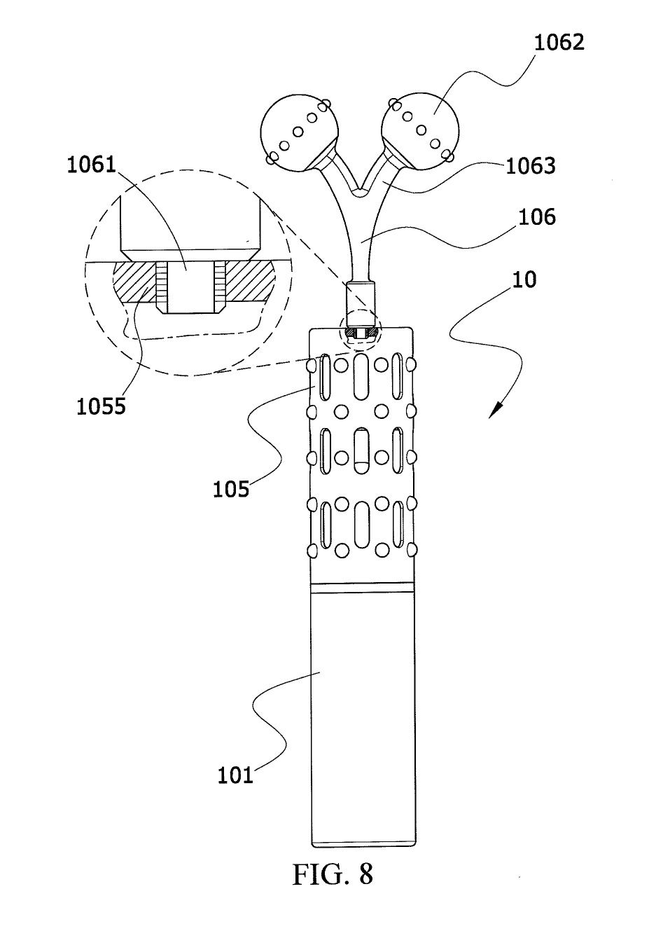

Referring to FIG. 8, another preferred embodiment (2) of the present invention is shown. As shown in the FIG. 8, in order to increase the practicability of the present invention, an assembly portion 1055 may be further formed at one end of the massage head 105, for example, a thread, so as to dispose a second massage head 106. A relative assembly portion 1061 is formed on the second massage head 106, so that the second massage head 106 is disposed on the assembly portion 1055 of the massage head 105 via the relative assembly portion 1061, so as to improve efficiency in use. The second massage head 106 may be, for example, the type in FIG. 8, which has two rollers 1062 capable of pressing each other relatively, and may press the neck or the cheek via an elastic pressure produced by two elastic portions 1063. FIG. 8 merely shows one of the types of the embodiment of the present invention, which is not intended to limit the types thereof.

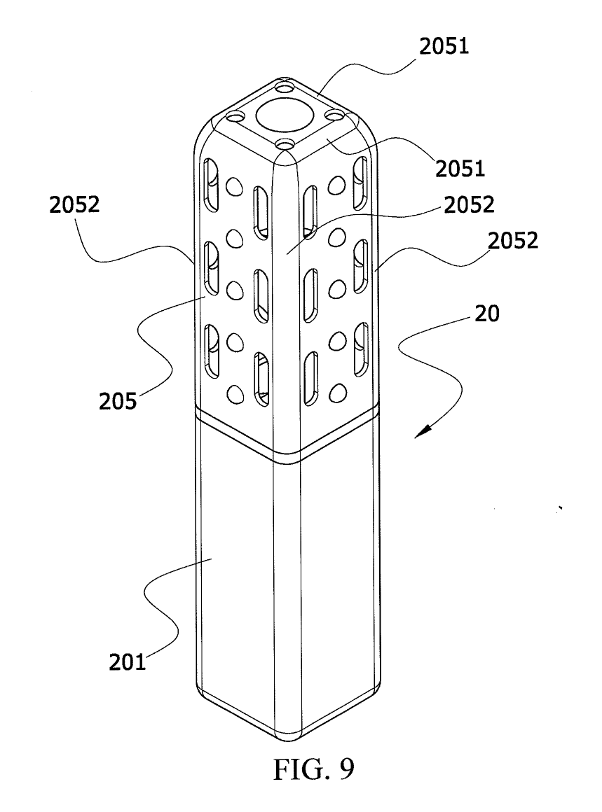

Referring to FIG. 9, another preferred embodiment (3) of the present invention is shown. As shown in FIG. 9, in the thermal type massage device 20, appearance of a holding base 201 and a massage head 205 is polygon-shaped (in the embodiment shown in FIG. 9, a quadrilateral is adopted, but the embodiment is not limited thereto, and may be other shapes such as triangle or hexagon). The massage head 205 has a massage effect during rotation via a rib portion 2052 formed between edges 2051 of the polygon.

To sum up, the present invention mainly uses an ignited catalyst body as a heat source, collocated with gas produced by a cotton material absorbed with volatile liquid, to produce continuous heat energy for the thermal type massage device. In this way, in addition to a massage effect, the thermal type massage device further has a thermal effect. In implementation, the massage device is light and is conveniently carried, and may be effectively used by the user anywhere since electricity is not required as the power source. Moreover, the heat source is produced via the oxidation of the catalyst body, which meets the safety requirement. Therefore, after the implementation of the present invention, the objective of providing a thermal type massage device with a simple structure, high safety, and both massage and thermal effects is achieved.

However, the above descriptions are merely preferred embodiments of the present invention, but are not intended to limit the scope of the present invention. Equivalent variation and modification made by persons skilled in the art without departing from the spirit and scope of the present invention should fall within the equivalent variation and modification of the present invention as well as the scope of claims.

What is claimed is:

1. A thermal type massage device, for a user to massage a body, and having both massage and thermal effects, comprising:
a holding base, formed with a accommodation space therein, wherein one end of the accommodation space is an open end, a catalyst body is disposed at the open end, a cotton material is disposed in the accommodation space, and the cotton material is absorbed with volatile liquid;
an hollow connection tube, having one end disposed at the open end of the accommodation space of the holding base and the other end disposed with a pivot, wherein an ignition opening is formed on a tube wall of the connection tube; and
a massage head, disposed at one end of the connection tube having the pivot, wherein the massage head is capable of rotating relatively to the holding base via the pivot.

2. The thermal type massage device according to claim 1, wherein, the catalyst body is a flame retardant cotton with a surface having platinum.

3. The thermal type massage device according to claim 1, wherein, an electronic ignition module is disposed above the catalyst body, the electronic ignition module has an electrical contact point, and a heat-conducting butt is connected to the electrical contact point.

4. The thermal type massage device according to claim 3, wherein, a terminal of the heat-conducting butt is in contact with a flame retardant cotton of the catalyst body.

5. The thermal type massage device according to claim 1, wherein, an air vent is formed on a surface of the massage head.

6. The thermal type massage device according to claim 1, wherein, a protruding particle is formed on a surface of the massage head.

7. The thermal type massage device according to claim 1, wherein, a protruding rib is formed on a surface of the massage head.

8. The thermal type massage device according to claim 1, wherein, the volatile liquid is alcohol.

9. The thermal type massage device according to claim 1, wherein, the volatile liquid is oil.

10. The thermal type massage device according to claim 1, wherein, an assembly portion is formed at one end of the massage head.

11. The thermal type massage device according to claim 10, wherein, a second massage head, with one end having a relative assembly portion, is capable of being disposed on the assembly portion of the massage head via the relative assembly portion.

12. The thermal type massage device according to claim 1, wherein, the massage head is polygon-shaped, and a rib portion is formed between one edge and another edge.

13. The thermal type massage device according to claim 1, wherein, the cotton material can be replaced by a sponge material.
